(19) United States
(12) Patent Application Publication
(10) Pub. No.: US 2008/0020835 A1
(43) Pub. Date: Jan. 24, 2008

(54) METHOD AND APPARATUS FOR SECURING GAMING MACHINE OPERATING DATA

(75) Inventor: Jamal Benbrahim, Reno, NV (US)

Correspondence Address: BEYER WEAVER LLP, P.O. BOX 70250, OAKLAND, CA, 94612-0250, US

(73) Assignee: IGT, Reno, NV (US)

(21) Appl. No.: 11/830,821

(22) Filed: Jul. 30, 2007

Related U.S. Application Data
(63) Continuation of application No. 09/880,474, filed on Jun. 12, 2001.

(51) Int. Cl. G06F 17/00

(52) U.S. Cl. 463/29; 713/187

(57) ABSTRACT

A method and apparatus for securing control or operating code or data of a gaming machine is disclosed. One embodiment of the method includes the steps of obtaining gaming device operational code encrypted in a symmetrical encryption process with a first private key, providing the encrypted code to the gaming device, decrypting the code using the first private key, storing the decrypted code at the gaming device, and utilizing the decrypted code to operate the gaming device. In one embodiment, the gaming device includes a master gaming controller having an associated memory, a processor for executing code, and a secure access module having the decryption key associated therewith.

### CROSS-REFERENCE TO RELATED APPLICATIONS

This application is a continuation application of and claims priority to commonly owned and co-pending U.S. patent application Ser. No. 09/880,474, filed on Jun. 12, 2001, entitled “METHOD AND APPARATUS FOR SECURING GAMING MACHINE OPERATING DATA”, which is incorporated herein in its entirety and for all purposes.

### FIELD OF THE INVENTION

The present invention relates to gaming machine control code or operational data, and more particularly, methods and apparatus for securing such code or data.

### BACKGROUND OF THE INVENTION

Gaming machines are well known and have a variety of configurations. These machines include those known as “slot” and “video” machines. In general, these machines are arranged to present a game for play by a player. When referred to as “gaming” machines, the machines are generally arranged to require that a player place a wager to be entitled to play the game and pay out winnings to the player in the event the player is a winner of the game.

These gaming machines are commonly controlled by gaming control code and operated with associated data. It is desirable to ensure that this code or data is secure. As will be appreciated, serious consequences may arise if the code is tampered with. For example, a perpetrator may attempt to alter the gaming machine control code so that game wins are registered with greater frequency, or winnings paid for normally non-winning events. No matter how accomplished, the perpetrator generally attempts to cause the code to allow the perpetrator to defraud the gaming machine and obtain money therefrom.

A problem with maintaining the gaming control code or other data secure is that in many instances, it is desirable to provide the code or data to the gaming machine from other than only a secure, read-only format. For example, so that different games may be played on a particular machine or various features of the machine updated, in many instances the gaming machine is arranged to accept new control code or other data. As stated above, however, it is necessary to ensure that the code or data provided to the gaming machine is secure.

### SUMMARY OF THE INVENTION

Methods and apparatus for securing gaming device control and operation code and data are disclosed.

In one embodiment of a method, control code or operational data is encrypted using a private key of a symmetrical encryption/decryption scheme. This encrypted code is provided to the gaming device. In one or more embodiments, the encrypted code is stored at a memory of the gaming device. Alternatively, the code is transmitted to the gaming device.

The gaming device is caused to seek the encrypted code and is then decrypted with the private key of the symmetrical encryption/decryption scheme. In one embodiment, when operation of the gaming machine is initiated, a decryption device or element is located, the encrypted code is located, and then the decryption device is utilized to decrypt the code.

Once decrypted, the code is stored at a memory of the gaming device for use in the operation of the gamine device. In one embodiment, the code comprises operating code enabling a gaming controller of the gaming device to present one or more particular games to a player. In another embodiment, the code comprises data for use in presenting a game or otherwise operating the gaming device. Such data may comprise audio and video data.

In one embodiment, after the code is decrypted, it is verified before it is stored or used. In one embodiment, the verification includes verification of certain token strings or signatures.

One embodiment of the invention comprises a gaming device for implementing the method of the invention. In one embodiment, the gaming device includes a gaming controller having a processor and an associated memory. The gaming controller also includes a secure access module. The decryption key is associated with the secure access module.

In one embodiment of the invention, operation of the gaming device includes the step of searching for the secure access module. The secure access module then searches for and obtains the encrypted code. The secure access module decrypts the code and stores it at the memory.

In accordance with the invention, all or substantially all of the code or data is encrypted, making the code or data unreadable without first being decrypted. Once encrypted, the code or data may be transmitted, stored or the like with little risk of tampering by an unauthorized party. The decryption key is associated with the secure access module and is thereby also securely maintained. In this manner, the gaming device control code or operating data is securely maintained.

Further objects, features, and advantages of the present invention over the prior art will become apparent from the detailed description of the drawings which follows, when considered with the attached figures.

### DESCRIPTION OF THE DRAWINGS

FIG. 1 illustrates one example environment of use of an apparatus and method of the present invention;

FIG. 2 is a block diagram of a gaming machine controller for implementing a method in accordance with the present invention;

FIG. 3 is a flow diagram illustrating in a method in accordance with an embodiment of the invention; and

FIG. 4 is a flow diagram illustrating a particular implementation of the method illustrated in FIG. 3.

### DETAILED DESCRIPTION OF THE INVENTION

The invention is a method and apparatus for securing control code or other data for use by a gaming machine. In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

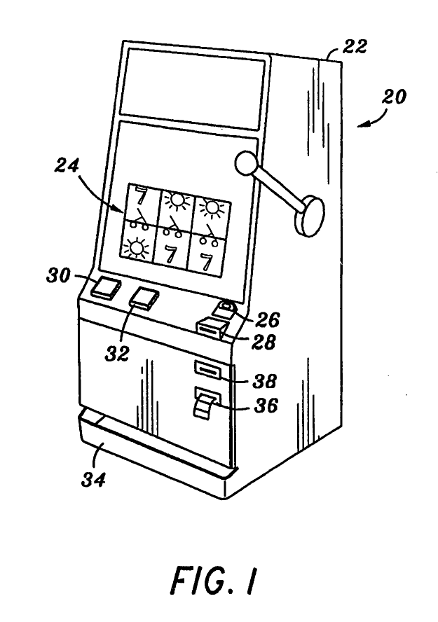

In general, the invention is a method and apparatus for providing secure code to a gaming device. As used herein, the term “code” generally means instructions or information in any of a variety of forms for use in controlling one or more functions of a gaming device. This code may comprise executable control code for controlling the operation of the gaming device or one or more aspects thereof, such as for presenting a game for play and controlling the various peripheral devices/features of the gaming machine, and/or may comprise operational information such as video data (such as for generation of images) or sound data (for use in generating sound) for use in presenting the game. The method and apparatus of the invention may be implemented in a wide variety of environments generally comprising computing environments, such as electronically and electro-mechanically controlled devices for presenting games. FIG. 1 illustrates the preferred environment to which the invention is applied, that of an electronic gaming device 20.

The gaming device 20 illustrated in FIG. 1 is illustrated as but one example of a device with which the invention is useful. As illustrated, the electronic gaming device 20 includes a cabinet 22 housing a display 24. The display 24 may comprise a video display or one or more mechanically or electro-mechanically controlled devices, such as reels. The display 24 comprises one peripheral of the gaming device 20.

In one embodiment of such a gaming device 20, a player is permitted to play a game once a bet has been placed. In order to place a bet, the player must first provide credit in the form of monies or other elements of value as required by the game operator. In the embodiment illustrated, the gaming device 20 includes a coin acceptor 26 for accepting one or more coins, tokens or the like. In general, the coin acceptor comprises another peripheral device, and may have at least the function of validating presented coins and indicating the value of the accepted coins. The device 20 illustrated also includes a bill validator 28 for accepting paper currency, tickets or the like. The bill validator 28 is yet another peripheral device, and may have at least the function of validating the presented bill monies and indicating the value of the accepted bills.

Once the player has provided the appropriate credit, the player is permitted to place a bet. In one embodiment, the device 20 includes a bet button 30 for indicating the desired bet to be placed. Once a bet is placed, the player is permitted to start the game. In the embodiment illustrated, the game involves the rotation of displayed reels. The player depresses a spin button 32, and the display is caused to display 24 images of simulated rotating reels.

A player may be paid a winning if the outcome of the game is a particular predetermined outcome as displayed by the display 24. These winnings may be paid by a coin dispenser (not shown) to a coin tray 34. Alternately, the player may be paid winnings in the form of a ticket dispensed by a ticket generator 36.

Many gaming devices, such as that illustrated, include a card reader 38 for reading information from a player card. This information may be used in a player tracking system, as is well known in the art.

In general, it will be appreciated that a gaming device 20 such as illustrated may include a variety of peripheral devices or elements for implementing the game, both in permitting input by a player and providing output to the player. These devices may include those described above and/or a wide variety of other devices. It will be appreciated that the present invention is applicable to a gaming device 20 such as that illustrated, and gaming devices arranged to present a wide variety of other games and configured in a wide variety of other manners.

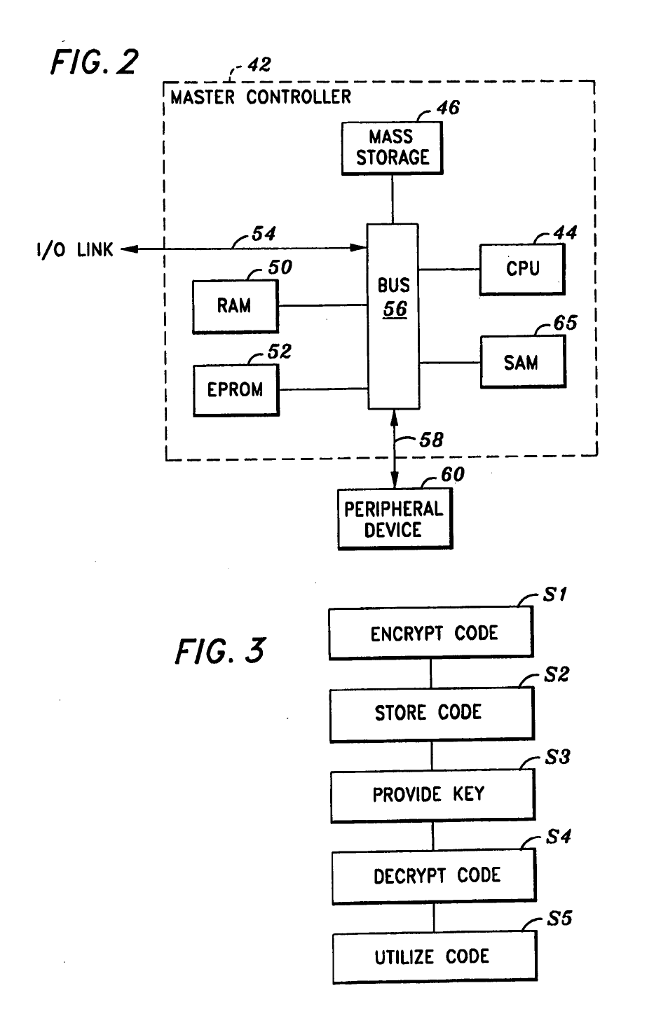

Referring now to FIG. 2, in a preferred embodiment of the invention, the gaming machine 20 includes a computing environment in which data is utilized to control the operation of the gaming device 20 or otherwise present a game for play by a player. In one or more embodiments, the gaming machine 20 includes a master gaming controller 42. As illustrated, the master gaming controller 42 includes a processor 44 and memory for storing data. In a preferred embodiment, the master gaming controller 42 includes a memory in the form of at least one data mass storage device 46. In one embodiment, the mass storage device 46 is capable of storing data comprising operational code. As is well known, the mass storage device(s) 46 may comprise a wide variety of devices and mediums capable of storing electronic data, such as a hard drive, CD-ROM, DVD-ROM, floppy disc, tape or the like.

In a preferred embodiment, the memory for storing data also includes one or more memory devices permitting higher speed data access. In one embodiment, this memory comprises read-only-memory (ROM) 50. The memory may comprise a variety of other data storage and access devices, such as static RAM, Dynamic RAM, Synchronous Dynamic RAM, RD RAM and FLASH ROM. Besides a mass storage device such as a hard drive, in one embodiment, the master gaming controller 42 includes a read-only memory device in the form of an EPROM 52. As described below, in the preferred embodiment, code enabling start-up of the gaming controller is contained on the EPROM, while game specific code is stored on the hard drive. Of course, the various code, including the boot-up and game code may be stored in a variety of manners using a variety of storage devices.

In one embodiment, a communications or data link 48 is provided between the master gaming controller 42 and another device. The other device may comprise a remote server or computer. The data link 54 permits transmission of data to and/or from the master gaming controller 42. The data link 54 may comprise a wired or wireless communications link, e.g. Ethernet, Token Ring, Firewire.RTM., etc. As stated above, the data link 54 may be useful in transmitting player tracking or similar information regarding play of the gaming device 20 to a remote location.

As is well known, appropriate input/output controllers and devices are provided for permitting data to flow to and from the processor 44 of the master gaming controller 42. In one or more embodiments, at least one bus 56 is provided for this purpose. In one or more embodiments, additional hardware and/or software may be provided for permitting communications with the master gaming controller 42 through the data link 54. For example, data may be transmitted through the link 54 using an IEEE-1394 protocol/architecture. In such an embodiment, a physical card including at least one port may be associated with the bus. This card may include hardware and/or software embodying the IEEE-1394 protocol, including physical, link and other layers as defined thereby. The port may be arranged to accept a network wire or cable. In this manner, data may be transmitted from the controller 42 to a remote location, or vice versa, over the link 54.

As illustrated, one or more peripherals 60 are associated with the master gaming controller 42. The peripherals 40 may include, but are not limited to, the display 24, coin acceptor 26, bill validator 28, ticket generator 36, and card reader 38 of the gaming machine 20 illustrated in FIG. 1. Those of skill in the art will appreciate that the peripherals 60 need not include all of those devices so described, and may include a variety of other devices. At least one communications or data link 58 is provided between each peripheral 60 and the master gaming controller 42. In one embodiment, the communications link 58 permits data to be transferred between the processor 44 of the master gaming controller 42 and each peripheral 60 via the system bus 56 of the master gaming controller 42. Again, this link may comprise a wired or wireless communications pathway.

In a preferred embodiment of the invention, the master gaming controller 42 includes a secure access module (SAM) 62. As described in greater detail below, the SAM is preferably a computing module which is capable of decrypting symmetrically encrypted data. In one embodiment, the SAM 62 includes a private key. Such modules are available, such as from Gemplus SA.

In accordance with the present invention, at least a portion of the code or data which is used to control or permit the operation of the gaming machine can be changed, such as by update or complete replacement. This code or data may be stored in a memory associated with the gaming device 20, such as the mass storage device 46 of the master gaming controller 42.

The configuration of the gaming device 20 described above is particularly adapted to implement a method of securing gaming machine control or operation data. Such a method is described in more detail below.

A method in accordance with the invention will be described with reference to FIG. 3. In one embodiment, in a first step S1, code to be provided to a gaming machine is encrypted. In the preferred embodiment of the invention, this step comprises encrypting all or substantially all of the code or data to be provided to the gaming machine using a key in a symmetrical encryption scheme. Such schemes include Data Encryption Standard (DES), FEAL, Blowfish, and IDEA. These encryption schemes are known to those of skill in the art. In general, in such schemes, a single key is provided and this key is both used to encrypt and decrypt the data. This key is referred to as the “private” key, as the key must remain private or secret to both the encryptor and decryptor, or else the data may be readily decrypted. In general, the keys which are used to encrypt and decrypt are referred to herein as comprising the same key. As is known in the art of symmetrical encryption however, the keys need not be perfectly identical, but may be slightly different from one another and still result in symmetrical encryption/decryption. As referred to herein, when the term “first key,” “private key” or similar terminology is referred to in the context of encryption and decryption, it is contemplated that the keys are of the type permitting symmetrical encryption/decryption and thus may be identical or trivially deviant.

In a step S2, the encrypted code is stored for later access and use by the gaming machine. As described in greater detail below, in one or more embodiments, the encrypted code may be stored on a hard drive associated with the gaming machine. In one or more other embodiments, the encrypted code may be stored remotely from the gaming machine.

In a step S3, the decrypting key (which may be referred to as the first or private key) is provided to the gaming machine. In one embodiment, the private key is stored on or embedded in the SAM 62. In one or more other embodiments, the private key may be provided as part of software of the gaming machine.

In a step S4, the private key provided to the gaming machine is utilized to decrypt the encrypted code. In the preferred embodiment of the invention, the private key is utilized to decrypt the symmetrically encrypted code. Such a decryption process is well known in the art.

In a step S5, the decrypted code is installed or otherwise executed by the gaming machine. In one embodiment, the decrypted code is stored in the RAM 50 of the gaming machine 20 and is utilized to control the operation of the machine.

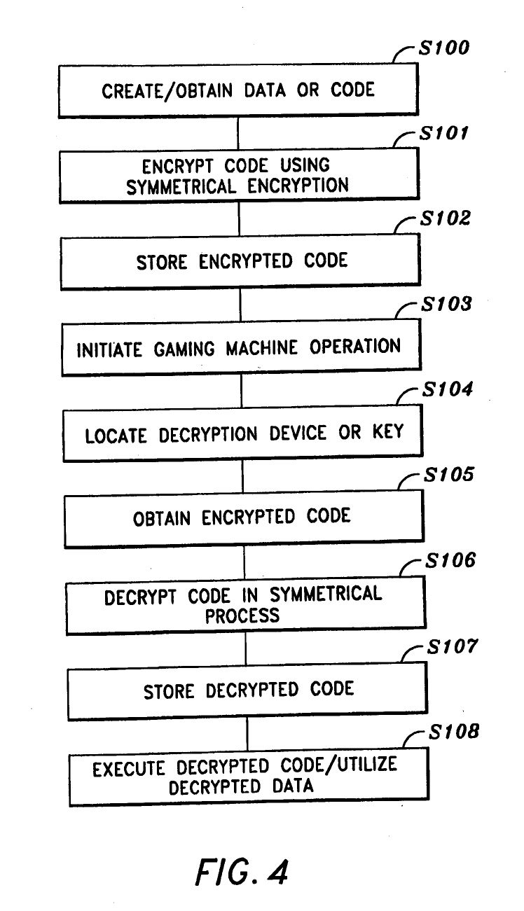

FIG. 4 illustrates an operation flow diagram of a particular implementation of the method illustrated in FIG. 3 and described above. In a step S100, code or data for use in controlling/operating a gaming machine is created or generated. This step may comprise, for example, creating code for controlling the overall operation of a gaming machine. In other embodiments, the step may comprise creating code for controlling only certain aspects of a gaming machine. The step may comprise generating data for use by the gaming machine used in its operation, such as sound or video data for use by the machine.

In a step S101, the code or other data is encrypted. As described above, this step preferably comprises encrypting the data using a private key in a symmetrical encryption process. The result of this step is the generation of encrypted code. As described above, it is preferred that the entirety of the code, or at least substantially all of the code be encrypted. In this manner, the code is not readable by a third party without first being decrypted.

In a step S102, the encrypted code is stored for access by the gaming machine. In one embodiment, the encrypted code is stored on the mass storage device 46 (such as a hard drive) of the gaming machine.

Of course, in one or more embodiments, the encrypted code may be stored between the time it is created and when it is transmitted and stored at the gaming device. For example, the code may be encrypted at a first computing device, and then stored on a CD-ROM. The encrypted code on the CD-ROM may be transferred from the CD-ROM to the mass storage device 46 of the gaming machine, such as via an optical reader associated with the gaming device.

In one or more other embodiments, the encrypted code is stored at a location remote from the gaming machine, but accessible thereby. For example, the encrypted code may be stored on a hard drive associated with a remote computing device, server or the like which is associated with the gaming machine 20 via a communications link, such as the communication link 54 described above.

In one or more embodiments, the encrypted code may be stored and then associated with the gaming device. For example, the encrypted code may be stored to a CD-ROM, and the code accessed directly by the gaming machine from that CD-ROM (and not stored to the hard drive of the gaming machine itself).

In a step S103, the operation of the gaming machine 20 is initiated. In a preferred embodiment, the master gaming controller 46 of the gaming machine 20 “boots” from code stored at the EPROM 52 or other secure memory device. Preferably, the EPROM 52 is programmed with authenticated operational code, such as at the location of the gaming device manufacturer. This operational code preferably includes the necessary base instructions for causing the master gaming controller 46 to begin operation, including performing the later described functions. Preferably, the EPROM 52 is not provided with code for implementing a particular game, but only such code as to enable operation of the master gaming controller 42 to be able to use other code for implementing a game.

In a step S104, a search is conducted for a decryption device. In a preferred embodiment, this step comprises providing the EPROM 52 with code causing a polling for a decryption device. In one embodiment, the polling is for a SAM, such as the SAM 62 of the master gaming controller 42.

In a step S105, the necessary code is obtained in decrypted form. In one embodiment, this step comprises the SAM 62 searching for the encrypted code and obtaining the code. In one or more embodiments, this step comprises the transferring of encrypted code from the mass storage device 46. In one or more embodiments, the code may be provided from a CD-ROM or through a communication link from a remote location.

In a step S106, the encrypted code is decrypted. In a preferred embodiment, this step comprises decrypting the encrypted code with they private key which is associated with the SAM 46. The private key may be a copy of the private key which is used to encrypt the code. As stated above, though the same term “private key” is used here to identify the key used to encrypt and decrypt, in the symmetrical encryption/decryption process these keys need not be identical to facilitate the process. Nonetheless, the same term is used because the keys are for practical purposes, the same.

In a step S107, the decrypted code is stored. In one or more embodiments, this step comprises storing the decrypted code to the RAM 50 or other high speed accessible memory of the master gaming controller 42.

In a step S108, the decrypted code is executed. In a preferred embodiment, this step comprises the processor 44 of the master gaming controller 42 executing or using the decrypted code to present a game or other data to the gaming device 20. In the event the code comprises data, then the execution step may simply comprise providing the data to a device of the gaming device. For example, the decrypted code may comprise audio data which is delivered to an audio system for generating particular sounds.

A variety of other embodiments of the invention are contemplated. In one or more embodiments, a plurality of SAMs may be provided, each having a different private key associated therewith. In this arrangement, blocks of code may be encrypted with different private keys and then selectively decrypted, as is desired, using a particular SAM having the corresponding private key. In this arrangement, an operator may decrypt only a specific portion or block of code/data from a group of code. For example, a gaming manufacturer may load two versions of operating code on a gaming machine 20 during manufacture. One version of the code may be for operation of the gaming machine 20 in one locale (such as the United States), and the other version of the code for operation of the gaming machine 20 in another locale (such as Australia). When the gaming machine 20 arrives at its particular destination, the operator may install a particular SAM. This SAM has a private key which will only decrypt the portion of the code which was encrypted with the corresponding private key. Preferably, the SAM is selected to decrypt the code which is necessary to operate the game in the particular jurisdiction in which the gaming device 20 is to be operated.

In one embodiment of the invention, the method of the invention may be accomplished without a SAM, and thus the gaming device 20 need not include a SAM. For example, in one embodiment, the private key necessary for decryption may be sent to the master gaming controller 42 from a remote location, such as by the data link 54. The key may be stored in the memory of the gaming controller 42.

In one embodiment, instead of providing a SAM, the decryption may be accomplished by software executed by the processor 44 of the gaming device 20. In such event, the private key may be stored at the gaming device 20 or be transmitted thereto.

In one embodiment of the invention, the decryption may occur through the RAM 50 or other memory, rather than the SAM 62. In such instance, the private key may be provided from the SAM or other location to the RAM 50. Because of the speed of data access at the RAM, such an arrangement may increase the speed of decryption.

In one or more embodiments, the SAM 62 or other hardware/software for accomplishing the decryption may be remote from the gaming device 20. For example, in one embodiment, when starting the operation of a gaming device 20, an operator may plug in a particular SAM or accomplish the decryption remotely, such as by uploading the encrypted code from the gaming device 20 through the communications link 54, decrypting it at a remote location (such as a remote computer having a SAM) and then transmitting the decrypted code back to the gaming device 20 for storage and execution.

In one or more embodiments, the initiation of the decryption process may be triggered by other than initiating operation of the gaming machine. This includes, for example, when a gaming machine is manufactured, shipped and installed at a particular location. When the gaming machine is turned on, it may then immediately seek the encrypted control/operation code and data to begin operation. In some instances, however, the gaming machine may already be operational and the operator may desire to provide new code to the gaming machine. This code may comprise code enabling the gaming machine to present an entirely new game, or may be as simple as new video data for presenting new images to players. In any event, in that instance, step S103 referred to above may comprise the step of causing the gaming machine to begin a code decryption and installation process. For example, the gaming controller 42 may be provided with a reset function which causes the controller 42 to seek new code, seek the decryption device/key, and then decrypt and use the code or data.

In one or more embodiments of the invention, the method may include additional authentication steps. In one embodiment, after the code or data is decrypted, some of the decrypted data may be confirmed. For example, the code may be provided with one or more token strings or signatures. After the code is decrypted, the method may include checking for these strings or signatures before the code or data is utilized in the operation of the gaming machine.

In one or more embodiments, the decrypted data may be transmitted to a remote source for authentication. For example, the decrypted data may be transmitted to a remote server having an authentic copy of the code/data against which the recently decrypted code may be verified. If the decrypted code does not match the authentic code, then it is determined that either the private key used to decrypt the data or the encrypted data itself was tampered with. In that event, the code or data is not used by the gaming machine, and any necessary steps may be taken to ensure the security of the gaming machine and associated code. For example, the private key may be erased and the encrypted code erased and the process started anew.

As stated above, in one embodiment, the key is stored at the SAM to maintain the security of the key. In one or more embodiments, the private key may be erased after use to prevent it from remaining available to a third party over time.

Many advantages are realized by the invention. In accordance with the invention, gaming control code is provided to a gaming device 20 in a totally encrypted format. Such a format prevents an outsider from viewing or using any of the code. This overcomes problems associated with asymmetric encryption techniques currently used today in which the code remains in a readable and usable form, and only a signature is encrypted and usable to ensure that the code is authentic. In accordance with the present invention, the entirety of the code is encrypted, preventing it from being seen or used by another without the required key for decryption.

The use of the symmetric encryption in accordance with the invention permits all or substantially all of the gaming code to be encrypted in a manner which is efficient. This method of encryption is very fast and thus does not slow the operation of the gaming machine 20. Asymmetric encryption is useful in encrypting data, but due to its complexities, is very slow and permits only the encryption of a signature (and not the entirety of the data) if the process is not to interfere with other activities. For example, some gaming devices are provided with limited computing power to reduce their cost of manufacture and repair. With the limited computing power, attempting to decrypt more than only an asymmetrically encrypted signature associated with code would result in slow or delayed operation of the device. Unlike the present invention, the complexity of asymmetric encryption and the necessity of significant processing power to accomplish asymmetric encryption/decryption prevents encryption of the entire data or even substantially all of the data. In accordance with the present invention, however, a security scheme provides for encryption of all or substantially all of the code/data.

The invention provides for a method of providing code to a gaming device in which the integrity of the code is ensured. Again, because the all or most of the code is encrypted, unauthorized persons may not view the code nor tamper with the code (if the code is tampered with, its execution will fail because it will not decrypt properly).

In accordance with the invention, decryption is conveniently accomplished, such as by resident software or a secure access module. A particular advantage of the module is that it is readily adaptable to the master gaming controller of currently existing gaming devices. Another advantage is that the private key is embedded in the module and thus does not need to be transmitted to the gaming device, lessening the risk that the private key may be intercepted and obtained by unauthorized persons.

It will be understood that the above described arrangements of apparatus and the method therefrom are merely illustrative of applications of the principles of this invention and many other embodiments and modifications may be made without departing from the spirit and scope of the invention as defined in the claims.

What is claimed is:

1. An apparatus to control code for operating a gaming device which initiates operation of a gaming device, comprising:
means for obtaining gaming device operational code reversibly encrypted with a first private key, the operational code comprising at least one of audio or video data used during play of a game on the device;
means for providing the encrypted operational code to the gaming device;
means for providing the first private key to the gaming device separately from the encrypted operational code;
means for decrypting the encrypted operational code using the first private key to recover the code;
means for storing the decrypted operational code at the gaming device; and
means for utilizing the decrypted operational code to control at least some audio or video aspect of the operation of the gaming device during operation of the gaming device by the player.

2. An apparatus to operate a gaming device, comprising:
means for providing on the gaming device executable code for a plurality of games including a first game and a second game, each of the plurality of games stored in an encrypted format, wherein the plurality of games comprise at least a first set of operating data for the first game comprising at least one of first audio data or first video data for generating the first game on the gaming device, and wherein the first set of operating data is encrypted with a first private key and storing a second set of operating data for the second game comprising at least one of second audio or second video data for generating the second game on the gaming device, wherein the second set of operating data is encrypted with a second private key;
means for providing the gaming device with only one of the first private key or the second private key to prevent execution of the first game or the second game on the gaming device;
means for decrypting, by the gaming device, one of the first set of operating data or the second set of operating data according to the one of the first private key or the second private key selected to recover the one of the first set of operating data or the second set of operating data;
means for sending, by the gaming device, information relating to the decrypted one of the first set of operating data or the second set of operating data to a remote device for authentication of the decrypted one of the first set of operating data or the second set of operating data;
means for taking remedial action by the gaming device when the decrypted one of first set of operating data or the second set of operating data is not authenticated by the remote device, wherein the remedial action includes not allowing the decrypted one of first set of operating data or the second set of operating data to be executed by the gaming device;
means for storing the decrypted one of the first set of operating data or the second set of operating data on the gaming device when the decrypted one is authenticated by the remote device; and
means for executing the first game or the second game on the gaming device utilizing the decrypted one of the first set of operating data or the second set of operating data when the decrypted one is authenticated by the remote device.
